(19) United States
(12) Patent Application Publication
(10) Pub. No.: US 2025/0238949 A1
(43) Pub. Date: Jul. 24, 2025

(54) DEVICES, SYSTEMS, AND METHODS FOR IMPROVED DETERMINATIONS OF COMPACTED FILL LEVELS

(71) Applicant: Compology LLC, Pittsburgh, PA (US)

(72) Inventors: Justin Armstrong, Pittsburgh, PA (US); Timothy Jay Longson, Pittsburgh, PA (US); Benjamin Chehebar, Pittsburgh, PA (US); Cason Male, Pittsburgh, PA (US); Jacob Junker, Pittsburgh, PA (US); Taylor Delehanty, Pittsburgh, PA (US)

(73) Assignee: Compology LLC, Pittsburgh, PA (US)

(21) Appl. No.: 19/034,039

(22) Filed: Jan. 22, 2025

Related U.S. Application Data
(60) Provisional application No. 63/623,716, filed on Jan. 22, 2024.

(51) Int. Cl. G06T 7/62; G06T 7/20

(52) U.S. Cl. CPC G06T 7/62; G06T 7/20

(57) ABSTRACT

A computer-implemented method for determining compacted fill level within a container is disclosed herein. The method can include receiving sensor data associated with an interior of the container from a content sensor, detecting contents within the interior of the container based on the sensor data, generating a flow parameter associated with the contents based on the sensor data, and determining the compacted fill level within the container based on the flow parameter.

### CROSS-REFERENCE TO RELATED APPLICATIONS

The present application claims the benefit of and priority under 35 U.S.C. § 119(e) to U.S. Provisional Patent Application No. 63/623,716, filed on Jan. 22, 2024, the disclosure of which is hereby incorporated by reference in its entirety herein.

### TECHNICAL FIELD

This invention relates generally to the image analysis field, and more specifically to new and useful devices, systems, and methods to autonomously determine compacted fill levels in the image analysis field.

### SUMMARY

The following summary is provided to facilitate an understanding of some of the innovative features unique to the aspects disclosed herein and is not intended to be a full description. A full appreciation of the various aspects can be gained by taking the entire specification, claims, and abstract as a whole.

In various aspects, a computer-implemented method for determining compacted fill level within a container is disclosed. The method can include receiving, via a processor, sensor data associated with an interior of the container from a content sensor, detecting, via the processor, contents within the interior of the container based on the sensor data, generating, via the processor, a flow parameter associated with the contents based on the sensor data, and determining, via the processor, the compacted fill level within the container based on the flow parameter.

In other aspects, a computing apparatus configured to determine a compacted fill level within a container. The computing apparatus can include a processor and a memory configured to store a fullness optical flow model that, when executed by the processor, causes the computing apparatus to receive sensor data associated with an interior of the container from a content sensor, detect contents within the interior of the container based on the sensor data, generate a flow parameter associated with the contents based on the sensor data, and determine the compacted fill level within the container based on the flow parameter.

In still other aspects, a system configured to determine a compacted fill level within a container is disclosed. The system can include a content sensor configured to generate sensor data associated with an interior of the container, and a computing apparatus communicatively coupled to the content sensor. The computing apparatus can include a processor and a memory configured to store a fullness optical flow model that, when executed by the processor, causes the computing apparatus to receive the sensor data associated with the interior of the container from the content sensor, detect contents within the interior of the container based on the sensor data, generate a flow parameter associated with the contents based on the sensor data, and determine the compacted fill level within the container based on the flow parameter.

These and other features and characteristics of the present disclosure, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention.

### BRIEF DESCRIPTION OF THE FIGURES

FIG. 1 illustrates an algorithmic flow diagram of a method of determining compacted fill levels, according to at least one non-limiting aspect of the present disclosure;

FIG. 2A illustrates a block diagram of a system configured to determine compacted fill levels, according to at least one non-limiting aspect of the present disclosure;

FIG. 2B illustrates a perspective view of one non-limiting aspect of the system of FIG. 2A, according to at least one non-limiting aspect of the present disclosure;

FIGS. 3A and 3B illustrate a perspective and side view, respectively, of a container of the system of FIG. 2A, according to at least one non-limiting aspect of the present disclosure;

FIGS. 4A and 4B illustrate schematic representations of various non-limiting examples of an optical flow model configured for use via the system of FIG. 2A, according to at least one non-limiting aspect of the present disclosure;

FIGS. 5A-5C illustrate schematic representations of additional non-limiting examples of an optical flow model configured for use via the system of FIG. 2A, according to at least one non-limiting aspect of the present disclosure;

FIG. 6 illustrates a schematic representation of a non-limiting example of a neural network configured for use via the system of FIG. 2A, according to at least one non-limiting aspect of the present disclosure;

FIG. 7 illustrates a non-limiting example of an output of the system of FIG. 2A, including determined optical flow parameters, according to at least one non-limiting aspect of the present disclosure; and

FIG. 8 illustrates a block diagram of a sub-system architecture configured for use by the system of FIG. 2, according to at least one embodiment of the present disclosure.

### DETAILED DESCRIPTION

The following description of the embodiments of the invention is not intended to limit the invention to these embodiments, but rather to enable any person skilled in the art to make and use this invention.

Numerous specific details are set forth to provide a thorough understanding of the overall structure, function, manufacture, and use of the aspects as described in the disclosure and illustrated in the accompanying drawings. Well-known operations, components, and elements have not been described in detail so as not to obscure the aspects described in the specification. The reader will understand that the aspects described and illustrated herein are non-limiting examples, and thus it can be appreciated that the specific structural and functional details disclosed herein may be representative and illustrative. Variations and changes thereto may be made without departing from the scope of the claims. Furthermore, it is to be understood that such terms as “forward”, “rearward”, “left”, “right”, “upwardly”, “downwardly”, and the like are words of convenience and are not to be construed as limiting terms.

As used herein, the term “system” can include one or more computing devices, servers, databases, memories, processors, and/or logic circuits configured to perform the functions and methods disclosed herein. As used herein, the term “sub-system” can include one or more computing devices, servers, databases, memories, processors, and/or logic circuits configured to perform a particular function and/or method as part of a broader system. However, depending on the context, the terms “system” and “sub-system” can be used interchangeably. For example, when discussed outside of the context of a higher-level system, devices described as “sub-systems” herein may be referred to as “systems.” As used herein, the term “device” can include a laptop computer, a personal computer, a server, a database, and/or a mobile computing device, such as a smart phone, wearable, and/or a tablet, a server, a personal computer, a laptop, a tablet, a wearable, and/or a mobile device, such as a smart phone.

As used herein, the term “volumetric fullness” shall include both “static fullness,” wherein the volume of non-compacted content within a container is determined, and “compacted fullness,” wherein the volume of compacted content within a container is determined. For example, according to some non-limiting aspects, “static fullness” can be determined via a static fill model, such as those disclosed in U.S. patent application Ser. No. 17/161,437, filed Jan. 28, 2021, titled METHOD AND SYSTEM FOR FILL LEVEL DETERMINATION, which published on May 27, 202 as U.S. Patent Application Publication No. 2021/0158097, the disclosure of which is hereby incorporated in its entirety by reference herein. “Compacted fill” can be determined using an optical flow model, such as those disclosed herein. However, as will be described in further detail herein, according to some non-limiting aspects, “compacted fill” can be determined using a combination of a static fill model and an optical flow model.

It can be extremely difficult to accurately determine the fill level of a container that houses contents that are continually compacted. For example, assessing the fullness of a trash compactor or baler can be difficult for several reasons. As an initial matter, trash compactors compress waste, making it hard to judge how much material has already been compacted versus how much space remains. The density of the compacted waste varies depending on the type of material (e.g., cardboard, plastic, general waste). Additionally, many compactors and balers are enclosed systems with small viewing windows or none at all, restricting the ability to visually inspect the amount of waste inside. Furthermore, waste materials are often irregular in shape and size, making it challenging to determine how efficiently the available space is being used. Gaps or uneven compaction can create the impression of fullness when more material could fit. Some compactors and balers lack accurate or automated fullness indicators, requiring manual inspection or guesswork. While some models have sensors, these may not always be precise, especially with mixed waste types.

To the extent that conventional devices, systems, and methods to accurately assess the fullness of contents within containers, such conventional devices, systems, and methods cannot accurately characterize or contextualize material spring-back. For example, certain materials, like cardboard or foam, may decompress (e.g., spring back) after compaction, creating an inconsistent gauge of fullness. Additionally, manually judging fullness often depends on the operator's experience. Inconsistent training or infrequent use of the equipment can lead to inaccurate assessments and inefficiencies. Moreover, manual assessment of a network of containers can be impractical—if not impossible—to perform at scale.

Accordingly, there is a need for devices, systems, and methods for improved determination of a compacted fill level. Variants of the devices, systems, and methods for fill level determination disclosed herein can confer several benefits over conventional systems and methods. First, variants of the technology can be readily applied across a variety of materials loaded into a container (e.g., a trash compactor). In an example, by training optical flow models tailored to the compactor environment on training data comprising imagery of a wide variety of content sensor types, the technology disclosed herein can apply more universally across content sensor types than existing systems and methods. Second, variants of the technology disclosed herein can reduce the power requirements (e.g., associated with illuminating an interior of a container, associated with computational processing power, etc.) of a content monitoring device (e.g., the content sensors) by sampling sensor data (e.g., imagery) at a low sampling rate (e.g., once per compaction cycle). Third, variants of the technology can save costs (e.g., associated with labor, associated with energy of transportation vehicles, etc.) for users of the system by enabling the users to accurately monitor the fullness of one or more containers. Fourth, variants of the technology can enable an accurate optical flow analysis of materials even when the materials undergo a large displacement between consecutive optical sensor measurements (e.g., images), as opposed to conventional optical flow methods (e.g., which may require small displacements between consecutive measurements in order to produce accurate results); for example, accuracy in such circumstances may be achieved by applying convolutional stacks of multiple convolutional layers to consecutive measurements to track the displacement of higher-level features across consecutive measurements. However, the technology can confer any other suitable benefits.

It shall be appreciated that, although trash compactors and balers are discussed by way of example, the devices, systems, and methods disclosed herein can be similarly implemented to improve the determination of a compacted fill levels of any container and/or contents, in accordance with user preference and/or intended application.

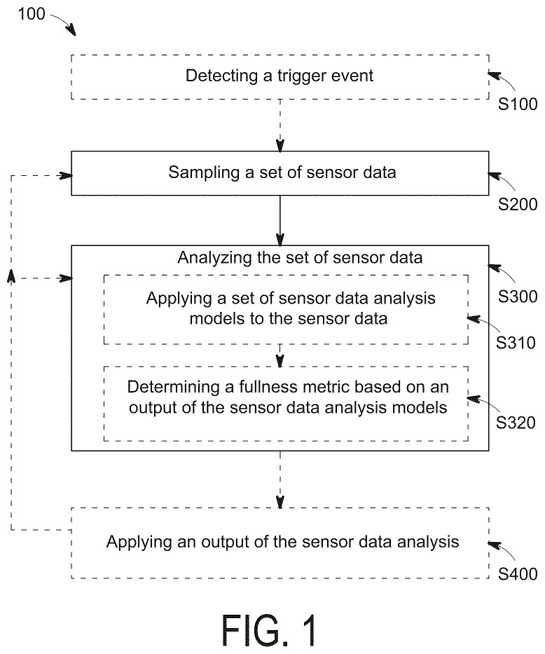

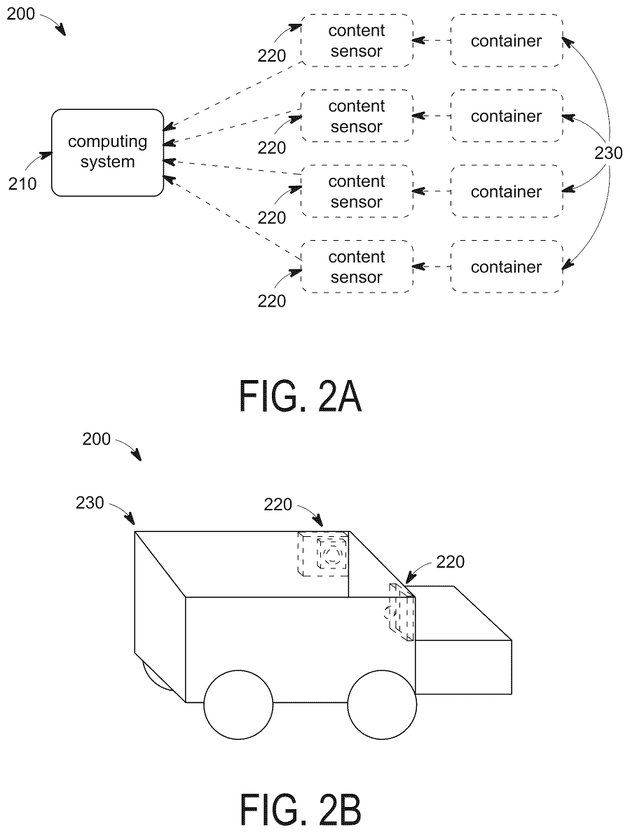

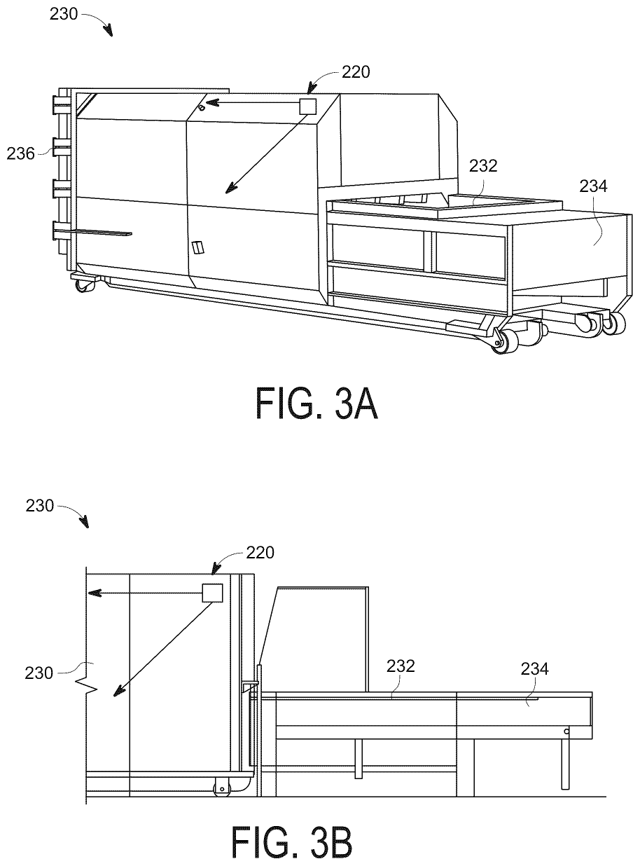

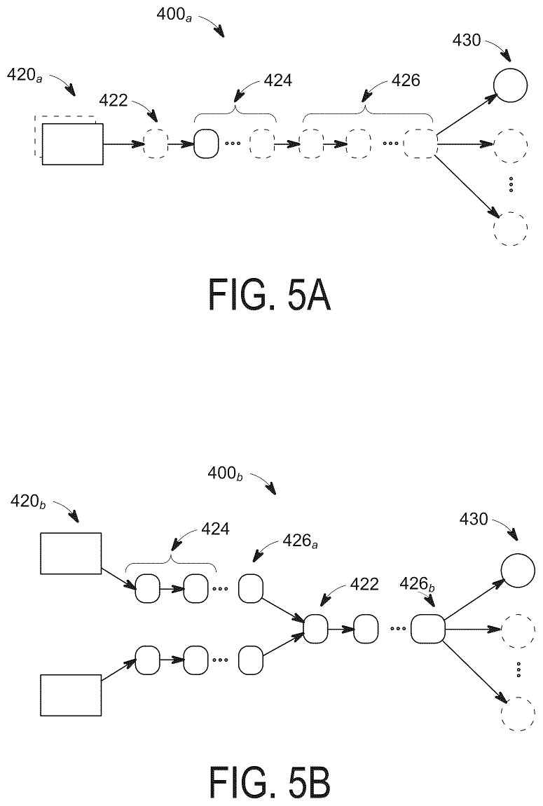

Referring now to FIG. 1, an algorithmic flow diagram of a method 100 of determining compacted fill levels is depicted according to at least one non-limiting aspect of the present disclosure. It shall be appreciated that the method 100 of FIG. 1 can be implemented by any of the devices and/or systems disclosed herein. For example, the method 100 of FIG. 1 can represent the specific algorithmic programming of a compacted fill determination engine or sensor data analysis models (e.g., optical flow model, static fill model, etc.) stored in a memory of a computing system 210 (FIG. 2) that, when executed by a processor of the computing system 210 (FIG. 2), can cause the computing system 210 (FIG. 2) to perform the steps of the method 100 of FIG. 1. As shown in FIG. 1, the method 100 can include detecting S100 a trigger event, sampling S200 a set of image data, analyzing S300 the set of image data, applying S400 an output of the image data analysis, and/or any other suitable steps. The specific nature of each step of the method 100 will be described in further detail after introducing specifics pertaining to the system 200 (FIG. 2) and the sensor data analysis models 410 (e.g., optical flow model, static fill model, etc.) (FIGS. 4A and 4B) employed by the compacted fill determination engine implemented by the system 200 (FIG. 2)

Referring now to FIG. 2A, a block diagram of a system 200 configured to determine compacted fill levels is depicted according to at least one non-limiting aspect of the present disclosure. As shown in FIG. 2A, the system 200 can include and/or interface with a computing system 210 (e.g., remote server), one or more containers 230, one or more content sensors 220 (e.g., imaging devices, vibration sensors, pressure sensors, audio sensors, etc.) associated with each container 230, and/or any other suitable elements to implement the functionality and methods disclosed herein. As previously stated, the method 100 of FIG. 1 is preferably performed using the system 200 of FIG. 2—and more specifically, the computing system 210—but can additionally or alternatively be performed by any other suitable system or components of the system 200 of FIG. 2.

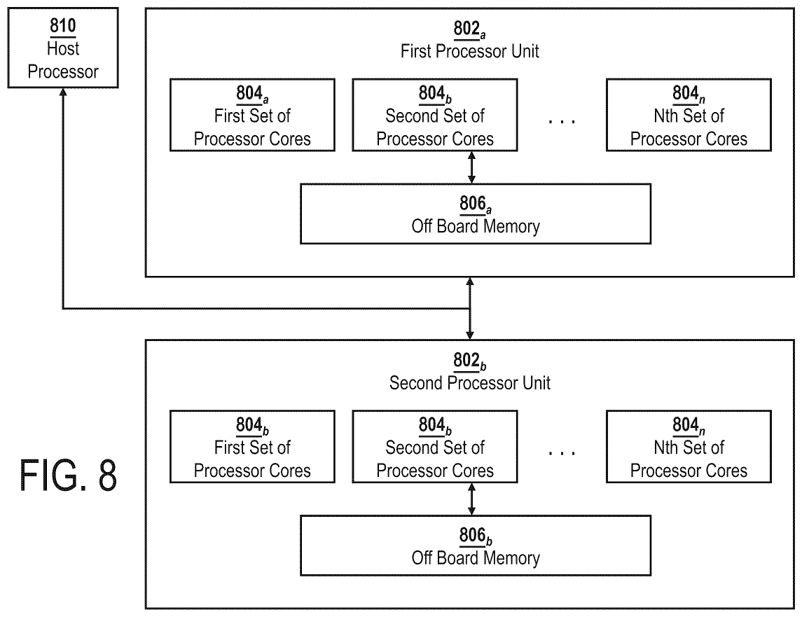

It shall be appreciated that the processors of the computing system 210 of the system 200 of FIG. 2A can include specialized processors, including central processing units (“CPUs”) or graphics processing units (“GPUs”) configured to execute a compacted fill determination engine that includes an optical flow model, as will be discussed in further detail with reference to FIG. 8. For example, according to some non-limiting aspects, the computing system 210 can include a sub-system architecture 800 (FIG. 8) that utilizes a set of GPUs and/or CPUs, as will be described in further detail with reference to FIG. 8.

The one or more containers 230 of the system 200 of FIG. 2A can include any container configured to contain and condense contents (e.g., a trash compactor, balers, etc.) to optimize the volumetric capacity of the container 230. For example, balers are machines configured to compress loose waste materials into dense, stackable bales. These can often be used for recycling, as many materials like cardboard, paper, and plastics are more valuable when tightly bundled. Compactors, on the other hand, can compress loose waste into smaller, more manageable forms, reducing the trash volume that must be hauled away. While compactors do not always create recyclable bales, they can lower disposal costs by minimizing the frequency and size of waste pickups. The container can be configured for either manual or autonomous compaction. The containers 230 can be further configured for vertical compaction, horizontal compaction and can be stationary, self-contained, and/or portable.

For example, according to the non-limiting aspect of FIG. 2A, the containers 230 preferably include compactors, which can further include a ram, a hopper, a pump (e.g., a hydraulic pump), a motor, and/or any other suitable elements. The compactor (e.g., auger compactor, vertical compactor, horizontal compactor, stationary compactor, portable compactor, pre-crusher compactor, marine compactor, transfer station compactor, etc.) can be a waste compactor (e.g., trash compactor, landfill compactor, medical waste compactor, apartment compactor, food compactor, etc.); a recycling compactor (e.g., for single-stream recycling, for dual-and/or multi-stream recycling, etc.) for compacting various recyclable goods (e.g., cardboard, plastic, metal, paper, textiles, wood, glass, electronic waste, etc.); and/or any other suitable compactor. In an example, each container 230 (or any suitable subset thereof) can be a compacting waste container 230. However, the containers 230 can additionally or alternatively include any other suitable dumpsters (e.g., front load containers, roll off containers, etc.), shipping containers (e.g., intermodal freight containers, unit load devices, etc.), sections of a vehicle (e.g., land, sea, air, and/or space vehicle) such as vehicle cargo holds, rooms of a structure (e.g., a fixed structure such as a building), and/or any other suitable containers.

Still referring to FIG. 2A, the one or more content sensors 220 can include any sensor configured to generate a visual output. For example, the one or more content sensors 220 can include a camera configured to generate image and/or video data. However, according to other non-limiting aspects, the one or more content sensors 220 can include an infrared sensor, a sonar, a radar, a light detection and ranging sensor, amongst others. It shall be appreciated that visual maps of the interior and contents of a container 230 can be generated using the one or more content sensors 220 and, therefore, can be provided to the computing system 210—and more specifically, a compacted fill determination engine—for processing.

For example, according to the non-limiting aspect of FIG. 2A, the content sensor 220 is preferably configured to sense (e.g., image) the interior of the container that it is associated with (e.g., image and/or otherwise sense the contents of the container), more preferably configured to sense substantially all of the interior but alternatively configured to image any suitable portion thereof. The content sensor 220 preferably has a fixed position and/or orientation relative to the container (e.g., is mechanically coupled to the container, preferably by a fixed coupling) but can alternatively have any other suitable spatial relationship with respect to the container (e.g., as shown in FIG. 2B). In variants, the content sensor 220 can be a standalone unit (e.g., mechanically coupled to the container), or can alternatively be integrated (e.g., electrically integrated) with the container (e.g., wherein the content sensor 220 can include a set of electrical connections to a power source of the container, a motor of the container, a pump of the container, a driving element of a ram of the container, etc.).

According to the non-limiting aspect of FIG. 2A, the content sensor 220 can preferably include one or more imaging devices. The imaging device can preferably include an optical sensor (e.g., camera), but can additionally or alternatively include an ultrasound imaging device and/or any other suitable imaging devices. Examples of optical sensors include a monocular camera, stereo camera, multi-lens or multi-view camera, color camera (e.g., a RGB camera) such as a charge coupled device (CCD) or a camera including a CMOS sensor, grayscale camera, multispectral camera (narrow band or wide band), hyperspectral camera, ultra-spectral camera, spectral camera, spectrometer, time of flight camera, high-, standard-, or low-dynamic range cameras, range imaging system (e.g., LIDAR system), active light system (e.g., wherein a light, such as an IR LED, is pulsed and directed at the subject and the reflectance difference measured by a sensor, such as an IR sensor), thermal sensor, infra-red imaging sensor, projected light system, full spectrum sensor, high dynamic range sensor, or any other suitable imaging system. The optical sensor is preferably configured to capture a 2-dimensional or 3-dimensional image, but can alternatively capture any measurement having any other suitable dimension. The image is preferably single, multi-pixel, time-averaged or sum total measurement of the intensity of a signal emitted or reflected by objects within a field of view, but can alternatively be a video (e.g., a set of images or frames), or any other suitable measurement. The image preferably has a resolution (e.g., cycles per millimeter, line pairs per millimeter, lines of resolution, contrast vs. cycles/mm, modulus of the OTF, or any other suitable measure) capable of resolving a 1 cm³ object at a sensor distance of at least 10 feet from the object, but can alternatively have a higher or lower resolution.

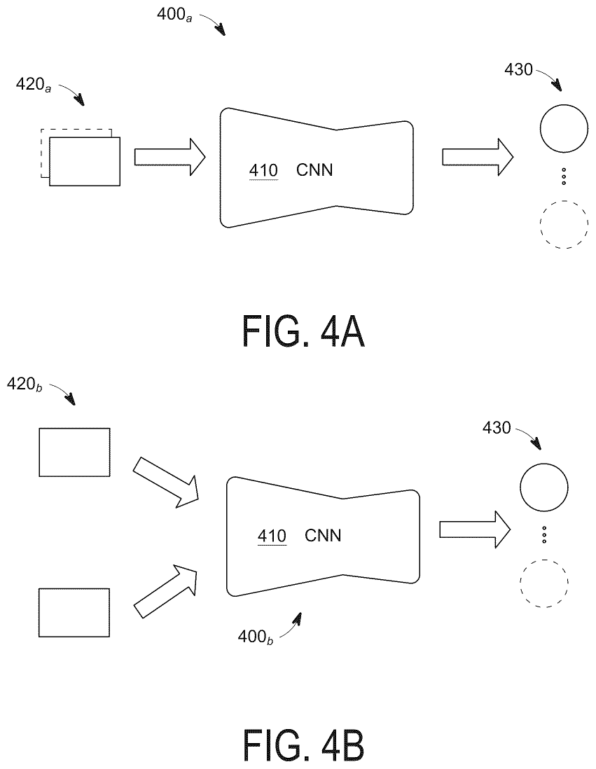

Referring now to FIGS. 3A and 3B, a perspective and side view of a container 230 of the system of FIG. 2A are respectively depicted according to at least one non-limiting aspect of the present disclosure. As shown in FIGS. 3A and 3B, the content sensor 220 can be positioned at a relatively high (e.g., highest in a vertical direction) corner proximal to (e.g., closest to) an ingress of the container 230 (e.g., the closest corner to an ingress between the hopper and the container, the closest corner to the ram, etc.), which can confer the advantage of delaying a time until the content sensor 220 view of the container 230 interior is obstructed by the container 230 contents, minimizing damage to the content sensor 220 and/or fouling of the content sensor 220 optics (e.g., due to delaying contact between the container contents and the camera), and/or other suitable advantages. The content sensor 220 and/or camera thereof can be configured with a view area directed towards a door of the container 230, away from the ingress of the container 230, and/or otherwise positioned (e.g., as shown FIGS. 3A and 3B). However, the content sensor 220 can be positioned proximal to a junction between a container 230 wall closest to ingress of the container 230 and a container 230 roof, and/or can be otherwise positioned.

The content sensor 220 can optionally include one or more emitters that are configured to emit electromagnetic signals, audio signals, compounds, or any other suitable interrogator that the content sensor is configured to measure. However, the content sensor 220 can additionally or alternatively measure signals from the ambient environment. Examples of sensor-emitter pairs include LIDAR systems, time-of-flight systems, ultrasound systems, radar systems, X-ray systems, and/or any other suitable systems. In embodiments in which the content sensor 220 includes an emitter, the content sensor 220 can optionally include a reference sensor that measures the ambient environment signals (e.g., wherein the content sensor 220 measurement can be corrected by the reference sensor measurement).

The content sensor 220 can optionally include a lens that functions to adjust the optical properties of the incident signal on the content sensor 220 (e.g., fish-eye lens, wavelength filter, polarizing filter, etc.), a physical or digital filter (e.g., noise filter), and/or any other suitable components to correct for interferences in a measurement. The content sensor 220 can optionally include one or more communication modules. The communication module preferably functions to communicate data to and from the content sensor 220 to a second system (e.g., the computing system 210 of FIG. 2A). Transmitted data can include measurements and sensor data from the content sensor 220 (and/or any other suitable components), processed measurements, instructions, pickup requests, and/or any other suitable data. The second system can include a device, server system, or any other suitable computing system 210 (FIG. 2A). The second system can be remote or wired to the communication system. Examples of the second system include a mobile device (e.g., smartphone, tablet, computer), server system, or any other suitable computing system. The communication system can be a wireless or wired communication system. The communication system can be a cellular, WiFi, Zigbee, Z-Wave, near-field communication system (e.g., Bluetooth, RF, NFC, etc.), Ethernet, powerline communication, or any other suitable communication system. The communication system can be preferably operable in a standby or off mode, wherein the communication system consumes power at a rate less than a threshold rate, and an on or communication mode, wherein the communication system consumes power at a rate required to communicate data. However, the communication system can be operable in any other suitable mode.

The computing system 210 (FIG. 2A) can function to perform any steps of the method, such as to receive data (e.g., image data, auxiliary sensor data) sampled by the content sensors 220 and/or any other sensors, detect a trigger event, analyze the set of image data (e.g., by executing a set of models), apply an output of the image data analysis, and/or otherwise function. The system 200 (FIG. 2A), including the content sensor 220, the computing system 210 (FIG. 2A), an auxiliary unit, etc., can optionally include one or more auxiliary sensors, such as IMU sensors (e.g., accelerometer, gyroscope, magnetometer, etc.), geopositioning elements (e.g., GPS receiver), weight sensors, audio sensors, vibration sensors, pressure sensors, electrical sensors, cameras, and/or any other suitable auxiliary sensors. However, the imaging devices can additionally or alternatively include any other suitable elements in any suitable arrangement. However, the system can include any other suitable elements and/or be otherwise composed.

In further reference to FIG. 1, the method 100 for fill level determination can include detecting S100 a trigger event. Detecting a trigger event S100 can function to determine a trigger event to prompt the content sensor 220 (FIG. 2A) to sample image data and/or other sensor data, and/or otherwise function. Additionally, or alternatively, S100 can include detecting a trigger event to prompt a supplementary action by the system 200 (FIG. 2A) (e.g., to provide an error warning to a user via a communication module). The trigger event can include and/or be associated with a position in a compaction cycle (e.g., ram cycle). However, the trigger event can additionally or alternatively include and/or be associated with a time elapsed since a last sensor measurement (e.g., image) was taken, receipt of an input (e.g., a commanded, a request, etc.), and/or any other suitable trigger. Preferably the position in the compaction cycle can include the end of a compaction cycle (e.g., after the ram has fully retracted), but can additionally or alternatively include the maximum compression point of the ram within the compaction cycle, the start of the compaction cycle, a set of points within the compaction cycle (e.g., evenly spaced in time), and/or any other suitable point within a compaction cycle, or between compaction cycles.

Additionally, or alternatively, the trigger event can be associated with an error event such as jamming of the compactor, a failure of a component of the compactor, and/or any other suitable error. In a first example, jamming of the compactor can be detected by analyzing sensor data (e.g., audio, vibration, etc.) for the presence of a feature (e.g., a clicking noise associated with metal grinding on metal). In a second example, jamming of the compactor can be detected by analyzing images and determining a lack of movement of the compactor ram. Detection of a trigger event can be further based on a set of features extracted from one or more auxiliary sensor measurements (e.g., audio, vibration, electrical signals, imagery, etc.). For example, detection S100 can include monitoring sensor data received from the content sensor 220 (FIG. 2A), for the presence of a feature value (e.g., threshold sensor data value, frequency, amplitude, etc.) and/or feature shape (e.g., shape of a plurality of consecutive measurements, peak, plateau, a magnitude of a change in a value, a rate of a change in a value, etc.) within the data that correlates to the trigger event.

Optionally, detection S100 can include calibrating a sensor 220 (FIG. 2A) reading for one or more containers 230 (FIG. 2A). In examples, calibration for a container 230 (FIG. 2A) can include collecting data from the auxiliary sensor of a content sensor 220 (FIG. 2A) after connecting the content sensor 220 (FIG. 2A) to the container 230 (FIG. 2A) (e.g., upon installation, upon maintenance, etc.), optionally labeling the collected data with the point (e.g., time point) that the trigger event occurred, and determining the feature value and/or feature shape corresponding to the trigger event for the container 230 (FIG. 2A).

According to some non-limiting aspects, detection S100 can include detecting the trigger event based on audio data (e.g., from a microphone). For example, detection S100 can include detecting a feature in the audio data (e.g., increase in volume, a shape of audio signals, heuristic classification of audio signals, audio signal analysis/classification using a statistical model such as a neural network and/or other machine learning techniques, etc.). In a first specific example, a spike in audio can indicate that the ram has started to engage, and a sudden decrease in audio can indicate that the ram has ceased to engage. In a second specific example, a change in the audio signal pattern can indicate that the ram has changed direction (e.g., has reached maximal compression). According to other non-limiting aspects, detection S100 can include detecting the trigger event based on vibration data (e.g., from a vibration sensor). For example, detection S100 can include detecting a feature in the vibration data (e.g., an increase in vibration magnitude, such as overall magnitude and/or magnitude at a particular frequency or within a particular frequency band, etc.; a shape of vibration signals; etc.). According to still other non-limiting aspects, detection S100 can include detecting the trigger event based on an electrical signal (e.g., received from electronic components of the content sensor connected to electronic components of the container). For example, the electrical signal (e.g., current, voltage, etc.) can be associated with a motor event (e.g., motor turned off, motor turned on, motor working above a threshold value, etc.), a pump event, an event associated with an electrical source of the container (e.g., a power reading from the building/power grid the container is connected to), and/or an event associated with any other electrical component of the container. According to still other non-limiting aspects, detection S100 can include detecting the trigger event based on an elapsed time (e.g., an elapsed time since a prior trigger event, an elapsed time since a prior measurement was sampled, etc.). For example, the content sensor 220 (FIG. 2A) can sample image data at a predefined frequency that is continuous (e.g., video) or intermittent (e.g., every second, every minute, hourly, daily, weekly, monthly, and interval therebetween, etc.). However, according to other non-limiting aspects, detecting S100 the trigger event can be otherwise performed based on any of the sensor inputs or information disclosed herein.

In further reference to FIG. 1, the method 100 can include sampling S200 a set of image data. For example, sampling S200 a set of image data can function to sample images of a container interior to assess the fullness of the container interior. Additionally, or alternatively, S200 can function to sample a set of input data for training a model (e.g., a static fullness model, a fullness optical flow model, etc.), and/or otherwise function. The image data can preferably include a set of one or more images. Each image is preferably associated with a container 230 (FIG. 2A) (e.g., by a container ID associated with the image). The image data is preferably sampled by the content sensor 220 (FIG. 2A) as described herein, but can be sampled by and received from any other suitable device. Sampling S200 can include illuminating the container 230 (FIG. 2A) interior and sampling an image. Sampling S200, for example, can be preferably performed in response to determination of the trigger event, thereby saving energy by not constantly monitoring the container 230 (FIG. 2A) but can alternatively be performed continuously and/or at any other suitable time(s). In specific examples, a set of one or more images are sampled after each compaction cycle, at the maximal compression of the ram, and/or at any other suitable time. Sampling S200 can further include sampling a single image at a time (e.g., sampling one image in response to determination of the trigger event). Additionally, or alternatively, sampling S200 can include sampling images continuously (e.g., video), sampling multiple images, wherein the multiple images are analyzed at S300 (e.g., wherein the clearest image is used, wherein an aggregated result from an analysis of the multiple images is used, etc.), and/or sampling any other suitable number of images.

According to some non-limiting aspects, sampling S200 can include not sampling images responsive to every trigger event. For example, sampling S200 can include sampling images less often when the container 230 (FIG. 2A) is below a critical threshold of fullness (e.g., as determined at a previous iteration of the method), such as every other compaction cycle, every third compaction cycle, and/or at any other suitable interval when the container has not yet been determined to have exceeded this fullness threshold (e.g., below 25%, 50%, 60%, 70%, 80%, 90%, 25-50%, 50-70%, or 70-90% full, etc.). Optionally, sampling S200 can include sampling images of a reduced quality and/or using a lower energy consumption sampling approach (e.g., taken at a lower resolution, taken with a light emitter controlled to illuminate at a dimmer setting, etc.) when the container 230 (FIG. 2A) is below a critical threshold of fullness (e.g., as determined at a previous iteration of the method). However, sampling a set of image data S200 can be otherwise performed.

Still referring to FIG. 1, the method 100 can further include analyzing S300 the set of sensor data generated by the content sensor 220 (FIG. 2A). For example, analyzing S300 the set of image data can function to assess images of containers 230 (FIG. 2A) with unknown fill levels, and/or otherwise function. According to some non-limiting aspects, analyzing S300 the set of image data S300 can optionally include applying S310 a compacted fill determination engine, including one or more sensor data analysis models (e.g., optical flow models, static fullness models, etc.), to the sensor data, determining a fullness metric based on an output of the sensor data analysis models S320, and/or any other suitable steps. The analysis S310 can be performed in response to sampling S200 the set of sensor data, but can additionally or alternatively be performed during training of the set of sensor data analysis models, after sampling S200, responsive to a request, and/or at any other suitable time. Optionally, the analysis S310 can be repeated responsive to an output of a preliminary analysis S300 and/or output of analysis S320 previously performed by the compacted fill determination model. For example, wherein an initial fullness metric estimate determined by a subset of sensor data analysis models (e.g., a static fullness model) could prompt analysis S310 by a further subset of sensor data analysis models (e.g., a fullness optical flow model).

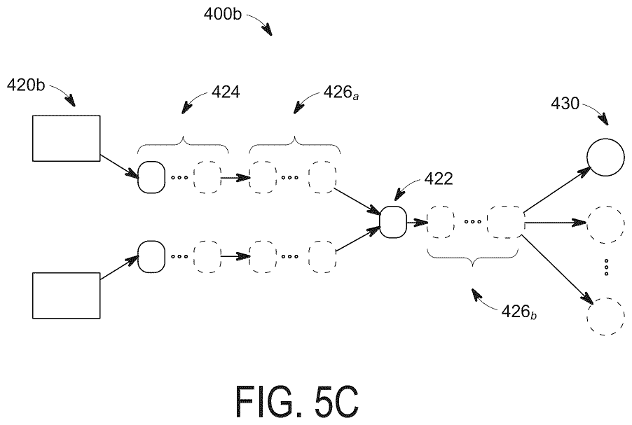

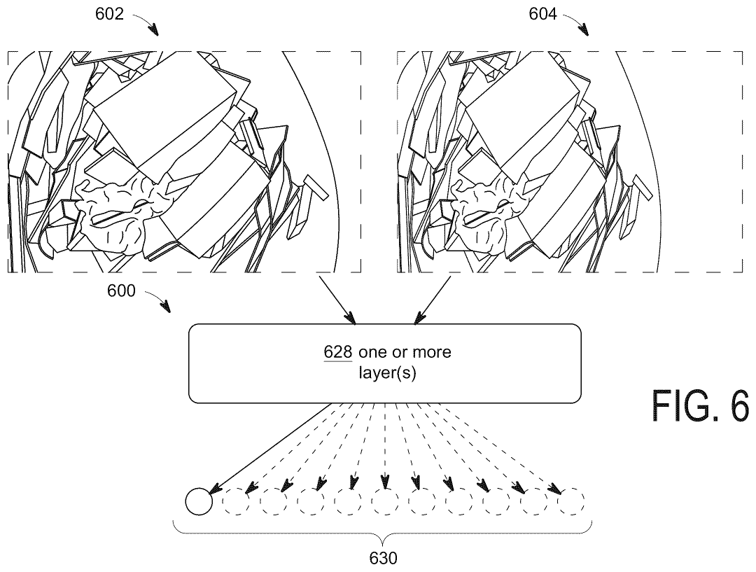

Still referring to FIG. 1, one or more of the sensor data analysis models can include a static fullness model, a fullness optical flow model, and/or any other suitable model. For example, according to some non-limiting aspects, one or more of the sensor data analysis models can be configured similar to those disclosed in U.S. patent application Ser. No. 17/161,437, filed Jan. 28, 2021, titled METHOD AND SYSTEM FOR FILL LEVEL DETERMINATION, which published on May 27, 202 as U.S. Patent Application Publication No. 2021/0158097, the disclosure of which is hereby incorporated in its entirety by reference herein. According to some non-limiting aspects, the one or more of the sensor data analysis models can include a neural network, which can include a deep neural network (“DNN”), but can additionally or alternatively include a convolutional neural network (“CNN”), a bifurcated network, a fully connected neural network, a V-NET, a Siamese network, and/or any other suitable network. As will be described in further detail with reference to FIGS. 5A-C, the neural network (e.g., the convolutional neural network) can include an assortment (e.g., a stack) of one or more of: input layers, output layers, convolutional (“CONV”) layers, pooling (“POOL”) layers (e.g., max pooling layers), correlation layers, activation layers (e.g., rectified linear unit (“ReLU”)), fully-connected layers, joining layers (e.g., concatenation layers, addition layers, fusion layers, etc.), normalization layers, batch normalization layers, hidden layers, and/or any other suitable layers. In one example, the neural network can include a series of convolutional layers, optionally including pooling and/or activation (e.g., ReLU) layers after some or all convolutional layers, and one or more fully connected layers (e.g., as shown in FIG. 6). However, the neural network can additionally or alternatively have any other suitable structure.

Applying S310 a set of sensor data analysis models to the sensor data can function to apply each of a set of one or more models trained to analyze a particular aspect of the sensor data, and/or otherwise function. For example, the models can be trained to extract one or more parameters from the sensor data that can be subsequently used to predict the fullness of the container 230 (FIG. 2A) at S320. According to one non-limiting aspect, application S310 of the sensor data analysis model can include analyzing the sensor data with a static fullness model to output a static fullness parameter. In examples, the static fullness model can include the fill level determination model described in U.S. patent application Ser. No. 16/709,127, which is included herein in its entirety by this reference. For example, the static fullness model can include a neural network trained by optimizing a set of weight values associated with each node of the neural network, and trained on a pair of images including a reference image (e.g., of the container 230 (FIG. 2A) when empty) and a subject image (e.g., a most recently sampled image, referred to equivalently herein as a “current image”) to output the static fullness parameter (e.g., fill level).

However, according to other non-limiting aspects, application S310 of the sensor data analysis model can include analyzing the sensor data with a fullness optical flow model, which can optionally function to perform an optical flow analysis between images of an image pair (e.g., to determine a distance of travel of contents within the container 230 (FIG. 2A) between consecutive images). As will be described in further detail herein, the fullness optical flow model can accept an image pair (e.g., a subject image and a prior image) as input, and output a set of one or more flow parameters indicative of motion distances of objects within the image (and/or values derived therefrom, such as one or more summary statistics thereof).

According to other non-limiting aspects, application S310 of the sensor data analysis model can include analyzing the sensor data with both a static fullness model and a fullness optical flow model, wherein an output of the static fullness model is provided to the fullness optical flow model as in input. For example, it shall be appreciated that, in a low fullness regime, compaction of contents within a container 230 (FIG. 2A) may have less of an impact on volumetric determination. Accordingly, application S310 of the sensor data analysis model can first include use of the static fill model to determine static fullness. If the determined static fullness indicates a low-fullness regime, application S310 of the sensor data analysis model may forgo use of the optical flow model to determine compacted fullness. However, if the determined static fullness indicates a medium or high-fullness regime, application S310 of the sensor data analysis model may include the use of the optical flow model to determine compacted fullness. It shall be appreciated that the use of a static fullness model first, to potentially reduce the use of an optical flow model, can save time, energy, and computational resources. This can promote operational efficiency as well as the rated life of components while reducing overhead expenses.

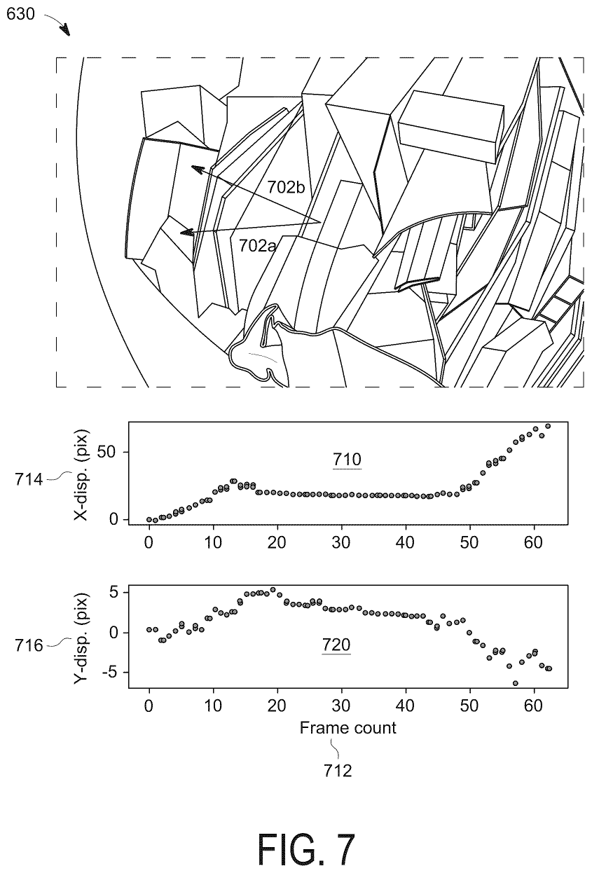

Regarding the fullness optical flow model, the set of flow parameters can summarize where, how far, and/or in which direction(s) contents captured within the sensor data have moved between consecutive images, and/or otherwise function. The set of flow parameters can include a flow field (e.g., a field of vectors assigned to each point in an image, representing local motion or displacement of pixels between consecutive images); one or more descriptive statistics (e.g., of the flow field), such as one or more optical flow vectors and/or magnitudes thereof (e.g., an average optical flow vector, optical flow vector of greatest magnitude, third quartile optical flow vector magnitude, etc.), one or more optical flow divergence metrics (e.g., indicative of the diversity of directions in which optical flow is observed, such as the extent to which flow is generally directed in a single direction, outward of a point, or inward toward a point, etc.), summary statistics (e.g., relative directions and/or magnitudes of flow of one or more objects in the container 230 (FIG. 2A)), a direction of maximal motion, a scalar (e.g., a magnitude of average displacement, a magnitude of maximal displacement, etc.); derived and/or calculated properties (e.g., material properties) of the contents of the container 230 (FIG. 2A); and/or any other suitable parameters. For example (e.g., see FIG. 7), the set of flow parameters can include one or more average optical flow vectors representing the average motion of the container 230 (FIG. 2A) contents between consecutive image pairs. Furthermore, the set of flow parameters can include a divergence metric, determined based on a distribution of a set of vectors (e.g., the flow field). For example, the inventors have discovered that at relatively lower levels of fullness the vectors of the flow field tend to point in a somewhat uniform direction (e.g., a substantially uniform direction of flow), whereas at relatively higher levels of fullness the vectors of the flow field tend to point in a somewhat outwards direction toward the edges of the image frame (e.g., indicating motion of the contents towards the camera lens).

In examples, the fullness optical flow model can include a classical optical flow model, a neural network (e.g., a DNN, a CNN, etc.), a bifurcated network, and/or any other suitable model. In examples, the fullness optical flow model can predict motion for a set of objects in the images (e.g., sparse flow), all pixels in the images (e.g., dense flow), a set of features within the image, and/or any other suitable targets. According to some non-limiting aspects, the fullness optical flow model includes a neural network (e.g., a CNN). The CNN preferably includes an assortment of one or more layers, which can include one or more layers described herein, such as one or more: convolutional (CONV) layers, joining layers (e.g., concatenation layers, addition layers, etc.), correlation layers, activation layers (e.g., rectified linear unit (ReLU)), fully-connected layers, output layers, pooling (POOL) layers (e.g., max pooling layers), hidden layers, normalization layers, and/or any other suitable layers. In one example, the CNN includes a sequence (e.g., stack) of convolutional layers, optionally including pooling, activation (e.g., ReLU), and/or any other suitable layers after some or all convolutional layers, and one or more fully connected layers. However, the CNN can additionally or alternatively have any other suitable structure.

As previously described, the fullness optical flow model 410 (e.g., a CNN optical flow model) can include multiple layers and can be provided with an image pair (e.g., the prior and the current image) as an input (e.g., examples shown in FIG. 5A and 5B). For example (e.g., as shown in FIG. 4A), a fullness optical flow model can include a first configuration 400ₐ configured to include stacking and/or layering an image pair 420ₐ and perform initial convolutions on the stacked image pair 420ₐ (e.g., applying a stack of one or more convolutional layers to the stacked image pair). According to another non-limiting aspect (e.g., as shown in FIG. 4B), the fullness optical flow model 410 can include a first configuration 400_{B} configured to apply a respective stack of one or more convolutional layers to an input 420_{b} that includes two or more non-stacked, separate images (e.g., prior to one or more joining layers 420, subsequent convolutional layers 424, fully-connected layers 426, output layers 430, and/or any other suitable layers, as shown in FIGS. 5A-C).

Additionally, according to the non-limiting aspect wherein a stack of one or more convolutional layers 426 (e.g., as shown in FIGS. 5B and/or 5C) is utilized, the optical flow model 410 can include two initial stacks, each preferably applied to one image of the image pair of the input 420_{b}. Each initial stack can include one or more convolutional layers 426ₐ, and can be followed by, preceded by, and/or intermixed with one or more additional layers (e.g., activation layers, etc.). The initial stacks are preferably joined by one or more joining layers 422 (e.g., concatenation layer, addition layers, fusion layers, etc.), and followed by a stack of one or more additional layers 426_{b}, which can include joining layers, correlation layers, convolutional layers, activation layers, pooling layers, output layers, and/or any other any other suitable layers. For example, each stack can include multiple convolutional layers, thereby enabling the respective stack to identify higher level features (e.g., item shapes, etc.) and/or items (e.g., boxes, bottles, etc.), rather than or in addition to lower-level features (e.g., edges, points, etc.) that may typically be detected and/or detectable by a smaller number of convolutional layers (e.g., one, two, etc.). Identifying higher level features can, according to some non-limiting aspects, confer the advantage of enabling the optical flow model to determine flow parameters (e.g., displacements) when the objects depicted in consecutive measurements have a relatively large displacement between the consecutive measurements. However, each stack can alternatively have a single convolutional layer, no convolutional layers, and/or any other suitable number of convolutional layers. Preferably, the two stacks are substantially identically structured with the same number, relative arrangement, and/or configuration (e.g., model weights) of layers. According to some non-limiting aspects, the two stacks can alternatively differ (e.g., based on a predicted difference in fullness between the prior and current image).

Applying S310 the sensor data analysis model can optionally include performing one or more signal processing techniques to enhance, compress, decompose, transform, detect features, and/or otherwise modify sensor data and/or an output of the set of sensor data analysis models. For example, the application S310 can include applying singular value decomposition (“SVD”) to an average optical flow vector to maximize signal in a determined dimension.

According to one non-limiting aspect, applying S310 the sensor data analysis model can include analyzing the sensor data with a dynamic optical analysis model. For example, the dynamic optical analysis model can be applied to a set of sensor data including video data. The dynamic optical analysis model 410 (FIGS. 4A and 4B) can be used to detect stress events, to determine one or more material properties (e.g., mechanical properties, such as elastic modulus) of the contents and/or elements thereof, to apply one or more optical flow analysis techniques to consecutive video frames (and/or any other suitable video frames), and/or be otherwise applied.

In further reference to the non-limiting aspect of FIG. 1, the method 100 can further include determining S320 a fullness metric based on an output of the sensor data analysis models to predict a compacted fullness of the container 230 (FIG. 2A). According to some non-limiting aspects, the determination S320 can be performed after S310 (e.g., based on the output of one or more sensor data analysis models), concurrently with S310 (e.g., wherein an sensor data analysis model outputs a fullness metric), and/or at any other suitable time. According to some non-limiting aspects, the fullness metric can be binary (e.g., needs dispatch vs. doesn't need dispatch, full beyond a threshold vs. not full beyond the threshold, 0 vs 1, etc.), a magnitude such as a scale (e.g., 0-1.0, 1-10, 1-5, 1-100, etc.), a percentage, and/or any other suitable magnitude, a qualitative value, a categorization (e.g., full, not full, partially full, almost full, etc.), a time (e.g., a predicted time until full beyond a threshold), and/or any other suitable fullness measure. This can be performed via one or more output layers 430 (FIGS. 4A-5C) of the model 410 (FIGS. 4A and 4B).

Determining S320 the fullness metric can optionally include determining a fullness regime, which can indicate a level of fullness of the container 230 (FIG. 2A) (e.g., as determined at a prior iteration of the method, as determined based on imaging of the current cycle, as determined based on imaging from a prior cycle, etc.). For example, applying S310 the model can include categorizing the level of fullness as belonging to one of three regimes, including low (e.g., less than about: 30%, 40%, 50%, 60%, 70%, etc.), medium (e.g., between about: 30%-90%, 40%-80%, 40%-60%, 50%-85%, 60%-95%, etc.), and high (e.g., greater than about: 60%, 70%, 80%, 85%, 90%, 95%, etc.). However, the application S310 of the model can include determining S320 the level of fullness as belonging to one of two regimes (e.g., full and not full), greater than three regimes, and/or otherwise categorize the level of fullness.

As previously discussed, determining S320 the fullness metric can optionally include combining the outputs of multiple models applied in S310, and optionally can further include differentially weighting the outputs of the multiple models based on a fullness regime. For example, the fullness metric can be determined based on one or more of an output of the fullness optical flow model, a static fullness parameter, and/or any other suitable parameters. According to some non-limiting aspects, different model outputs can be stronger predictors of the fullness of a compactor container 230 (FIG. 2A) at varying regimes of fullness. In an example, at a relatively low (e.g., less than about 50%), medium (e.g., between about 50%-85%), and high (e.g., greater than about 85%) fullness regime, the strongest indicator of fullness (e.g., strongest predictor of an accurate fullness metric within the regime) can be an output of the static fullness model (e.g., a static fullness parameter), a first output of the fullness optical flow model (e.g., an optical flow vector, a magnitude of average displacement, etc.), and a second output of the fullness optical flow model (e.g., a divergence metric), respectively. Additionally or alternatively, determining S320 the fullness metric can optionally include only determining a subset of sensor data analysis model outputs corresponding to the strongest predictor based on the fullness regime, and predicting the fullness only with the subset (e.g., only predicting fullness with the static fullness model for a low fullness regime, only predicting fullness based on a divergence metric for a high fullness regime, etc.), such as wherein the model used to predict fullness can be determined based on a previous fullness determination (e.g., most recent prior determination), can be determined based on an attempted determination that indicates the fullness has deviated from the predicted regime (e.g., first using a static fullness model to evaluate fullness, then, based on determining a prediction that exceeds the low fullness regime, additionally or alternatively using the fullness optical flow model to evaluate fullness), and/or can be determined in any other suitable manner.

According to one non-limiting aspect, determining S320 (FIG. 1) the fullness metric based on an output of the sensor data analysis models can include performing a weighted regression using a set of outputs of the sensor data analysis models. In examples the regression explanatory variables can include scalar values output by the sensor data analysis models, coefficients from a vector and/or matric output by the sensor data analysis models, values extracted from an output of the sensor data analysis models, and/or any other suitable inputs. In examples the regression response variable (e.g., ground truth values for fullness) can be determined based on: labelled data, experimental data (e.g., on how many compaction cycles occur after a determination of 100% full and prior to a pickup), a human dispatcher decision and/or assessment (e.g., needs pickup soon, not yet full, etc.), information on the weight of a plurality of containers 230 (FIG. 2A) when taken to a facility (e.g., trash facility), and/or any other suitable information.

According to another non-limiting aspect, determining S320 (FIG. 1) the fullness metric based on an output of the sensor data analysis models can include detecting a change in one or more outputs over time. In a first example, S320 (FIG. 1) can include determining the fullness metric based on a known relationship between the rate of flow (e.g., displacement) and/or change in rate of flow between consecutive frames and the fullness. Generally, within a low fullness regime the rate of flow of the container 230 (FIG. 2A) contents increases over time until a medium fullness regime, where the rate of flow of the container 230 (FIG. 2A) contents slows over time until ultimately rising in a high fullness regime (e.g., see FIG. 7). Additionally, determining S320 (FIG. 1) the fullness metric can include determining the fullness metric based on an aggregate metric (e.g., dead reckoning). For example, at each compaction cycle (e.g., since the last time that the container 230 (FIG. 2A) was serviced, otherwise emptied, and/or otherwise known to be empty, substantially empty, or almost empty; since the last time that an accurate fullness metric for the container 230 (FIG. 2A) was known; etc.), S320 (FIG. 1) can include determining a volume of material added to the container since the prior cycle, and adding this to an aggregate container 230 (FIG. 2A) volume metric.

According to still other non-limiting aspects, determining S320 (FIG. 1) the fullness metric based on an output of the sensor data analysis models can include determining that the output of only a subset of the sensor data analysis models should be used, which can function to reduce a computational and power load on the content sensor 220 (FIG. 2A) and/or computing system. For example, the determination S320 (FIG. 1) can include determining the fullness metric based only on an output of the static fullness model below a threshold fullness (e.g., <25%, <30%, <40%, <50%, <60%, etc.). Additionally, the determination S320 (FIG. 1) can include determining the fullness metric based only on an output of the fullness optical flow model above a threshold fullness (e.g., >40%, >50%, >60%, >70%, >80%, etc.).

According to one non-limiting aspect, determining S320 (FIG. 1) the fullness metric can include combining multiple models and/or approaches described herein. For example, determining the fullness metric can include applying an ensemble model (e.g., an ensemble neural network), the ensemble model including the static fullness model and the fullness optical flow model. Additionally, determining the fullness metric can include applying one or more data fusion (e.g., sensor fusion) techniques to decrease uncertainty associated with fullness metric estimates derived from individual data sources (e.g., sensors, model outputs, etc.). For example, multiple instances of a model type (e.g., a static fullness model, a fullness optical flow model, etc.) can be tailored to interpret data from different data sources (e.g., different sensor types), and data fusion techniques can be used to combine the outputs of the multiple model instances to generate the fullness metric. Additionally, outputs of a set of models determining an instantaneous fullness estimate (e.g., a static fullness model analyzing a most recently sampled image, a fullness optical flow model comparing a most recently sampled image with a prior image) and a set of models analyzing an aggregated change in fullness over time (e.g., via a dead reckoning approach as described herein) can be combined to generate the fullness metric. However, analyzing the set of sensor data S300 can be otherwise performed.

According to the non-limiting aspect wherein sensor fusion is employed, image data can be used in conjunction with additional data (e.g., audio data, pressure data, vibration data, etc.) generated by the one or more content sensors 220 (FIG. 2A) to determine fullness. Audio data (associated with initiation of a compaction event), for example, can be utilized to improve the fullness determination by providing additional context to the image data (e.g., knowledge that the compaction event just occurred and the contents is in a compacted state). Likewise, pressure data (associated with the ram) can be implemented to assess how much pressure is applied by the content on the ram during the compaction event, which can be a further indicator of container 230 (FIG. 2A) fullness. In other words, according to some non-limiting aspects, additional data (e.g., audio data, pressure data, vibration data, etc.) can be correlated to container 230 (FIG. 2A) fullness regime and/or container 230 (FIG. 2A) context that can be associated with a particular fullness regime. Thus, the combined use of one or more content sensors 220 (FIG. 2A) can improve the fullness determinations disclosed herein.

The method 100 of FIG. 1 can further include applying S400 an output of the sensor data analysis, and/or any other suitable steps. However, the method can be otherwise performed. Applying S400 an output of the sensor data analysis can include use of the fullness metric for an additional application beyond predicting fullness. For example, the additional application can include taking an action, such as dispatching a pickup of container 230 (FIG. 2A) contents, dispatching container servicing in the case of a container 230 (FIG. 2A) error (e.g., jammed ram) and/or content sensor 220 (FIG. 2A) error (e.g., obstructed lens, faulty content sensor 220 (FIG. 2A), etc.), determining material properties of container 230 (FIG. 2A) contents (e.g., Young's modulus, etc.), determining contaminants in container 230 (FIG. 2A) contents, and/or any other suitable application.

According to some non-limiting aspects, applying S400 (FIG. 1) the output can be performed after the analysis S300, wherein an output of S300 (e.g., the fullness metric) of the aforementioned models is applied S400. However, according to some non-limiting aspects, the application S400 can additionally or alternatively be performed after sampling S200, wherein an output of the sampling S200 (FIG. 1) (e.g., sensor data) can be applied S400 (FIG. 1) (e.g., wherein the sensor data is transmitted to an external entity), and/or at any other suitable time. The application S400 (FIG. 1) of an output can optionally be performed in response to a request. Dispatching a pickup of container 230 (FIG. 2A) contents based on the fullness metric can function to reduce a cost (e.g., monetary, environmental cost of fuel for transportation between the container 230 (FIG. 2A) and a facility, time cost of labor, etc.) associated with the pickup. Dispatching can include triggering a dispatch, delaying a dispatch, optimizing a dispatch schedule for one or more containers 230 (FIG. 2A)s, and/or any other suitable actions. For example, the fullness measure can be provided to a scheduling algorithm, and pickup times per container 230 (FIG. 2A) can be optimized across customer sites. Additionally, S400 (FIG. 1) can include predicting long-term trends for each of a plurality of containers 230 (FIG. 2A)s, scheduling pickups to each of the plurality of containers 230 (FIG. 2A) based on the predicted long-term trends, and optionally triggering an additional pickup if a container 230 (FIG. 2A) reaches a threshold fullness earlier than predicted and/or triggering a delay in a pickup if a container 230 (FIG. 2A) does not reach a threshold fullness by a predicted time.

Determining contaminants in container 230 (FIG. 2A) contents can include determining (e.g., quantify) a contamination observable in the sensor data. Determining the contamination can optionally include determining a contamination metric, which can be a number of contaminant items, a contamination percentage (e.g., by weight, by volume, etc.) and/or any other suitable contamination metric. In examples, the contamination can be determined using one or more statistical classification, image classification, machine learning, and/or computer vision techniques (e.g., using a neural network, such as a DNN and/or CNN, trained to detect contaminants), manual labeling, and/or any other suitable techniques. For example, contamination can be determined as described in U.S. patent application Ser. No. 17/145,021, filed Jan. 8, 2021 and titled METHOD AND SYSTEM FOR CONTAMINATION ASSESSMENT, which published as U.S. Patent Application Publication No. 2021/0158308 on May 21, 2021, the disclosure of which is hereby incorporated in its entirety by reference herein. However, according to some non-limiting aspects, applying S400 an output of the sensor data analysis can be otherwise performed.

According to some non-limiting aspects, the method 100 of FIG. 1 can include repeating any or all of steps S100-S400 (e.g., consecutively, within a given iteration of the method, such as shown by way of example in FIG. 1, etc.). For example, consecutive iterations of the method 100 (FIG. 1) can be performed continuously (e.g., for continual monitoring of a container 230 (FIG. 2A)). Additionally, the method 100 (FIG. 1) can include re-sampling S300 sensor data based on a result of the analysis (e.g., a classification of insufficient image quality).

Different processes and/or elements discussed above can be performed and controlled by the same or different entities. In the latter variants, different subsystems can communicate via APIs (e.g., using API requests and responses, API keys, etc.), requests, and/or other communication channels. Communications between systems can be encrypted (e.g., using symmetric or asymmetric keys), signed, and/or otherwise authenticated or authorized.

According to some non-limiting aspects, the above functionality, methods and/or processing modules can be implemented via non-transitory computer-readable media, storing computer-readable instructions that, when executed by a processing system, cause the processing system to perform the method(s) discussed herein. The instructions can be executed by computer-executable components integrated with the computer-readable medium and/or processing system. The computer-readable medium may include any suitable computer readable media such as RAMs, ROMs, flash memory, EEPROMs, optical devices (CD or DVD), hard drives, floppy drives, non-transitory computer readable media, or any suitable device. The computer-executable component can include a computing system and/or processing system (e.g., including one or more collocated or distributed, remote or local processors) connected to the non-transitory computer-readable medium, such as CPUs, GPUs, TPUS, microprocessors, or ASICs, but the instructions can alternatively or additionally be executed by any suitable dedicated hardware device.

Aspects of the devices, systems, and methods disclosed herein can include every combination and permutation of the various variants, system components, and the various method processes, wherein one or more instances of the method and/or processes described herein can be performed asynchronously (e.g., sequentially), concurrently (e.g., in parallel), or in any other suitable order by and/or using one or more instances of the systems, elements, and/or entities described herein. As a person skilled in the art will recognize from the previous detailed description and from the figures and claims, modifications and changes can be made to the embodiments of the invention without departing from the scope of this invention defined in the following claims.

Referring now to FIG. 6, a schematic representation of a non-limiting example of a neural network 600 configured for use via the system of FIG. 2A is depicted according to at least one non-limiting aspect of the present disclosure. Specifically, the neural network 600 can be configured to function as an optical flow model of the compacted fullness determination engine, as previously discussed. For example, FIG. 6 illustrates how the neural network 600 can be configured to receive an input that includes first sensor data 602 (e.g., an image) and second sensor data 604 (e.g., an image). It is evident from FIG. 6 that the contents of the container has been compacted.

According to FIG. 6, the sensor data 602, 604 can be either stacked, as depicted in FIGS. 4A and 5A, or non-stacked, as depicted in FIGS. 4B, 5B, and 5C. For example, the sensor data 602, 604 can be separate frames of a video, or before and after images taken at two different times during a fill cycle of a container 230 (FIG. 2A). For example, the first sensor data 602 can include image data of the contents of the container 230 (FIG. 2A) prior to a detected trigger event, and the second sensor data 604 can include image data of the contents of the container 230 (FIG. 2A) after the detected trigger event. According to FIG. 6, the neural network 600 can process the sensor data 602, 604 via using a plurality of layers 628, as described in reference to FIGS. 4A-5C, generating an output 630. The output 630 can include determining S320 (FIG. 1) the fullness metric and applying S400 an output of the sensor data analysis, as described in further detail with reference to FIG. 1.

Referring now to FIG. 7, a non-limiting example of an output 630 of the system of FIG. 2A, including determined optical flow parameters, is depicted according to at least one non-limiting aspect of the present disclosure. For example (e.g., see FIG. 7), the set of flow parameters can include one or more average optical flow vectors 702ₐ, 702_{b} representing the average motion of contents within the container 230 (FIG. 2A) contents between the first sensor data 602 and the second sensor data 604. For example, a first flow vector 702ₐ can illustrate a net displacement of contents after summing all the vectors from the optical flow vector field. This can indicate how much and in what direction contents within the container are flowing. A second flow vector 702_{b} can match the coordinate space used to plot X and Y displacement in one or more subplot 710, 720. A first subplot 710, for example, can be generated to illustrate the flow within the container horizontal axis (X). Likewise, a second subplot 720 can be generated to illustrate the flow within the container vertical axis (X). It shall be appreciated that neither axis will match the perceived axes in the output 630 due to the position of the content sensor 220 (FIG. 2A).

According to other non-limiting aspects, the output 630 can include a set of additional flow parameters, such as a divergence metric, determined based on a distribution of a set of vectors 702ₐ, 702_{b} (e.g., the flow field). For example, at relatively lower levels of fullness the vectors 702ₐ, 702_{b} of the flow field tend to point in a somewhat uniform direction (e.g., a substantially uniform direction of flow), whereas at relatively higher levels of fullness the vectors 702ₐ, 702_{b} of the flow field tend to point in a somewhat outwards direction toward the edges of the image frame (e.g., indicating motion of the contents towards the camera lens).

Referring now to FIG. 8, a block diagram of a sub-system architecture 800 configured for use by the system 200 of FIG. 2 is depicted in accordance with at least one embodiment of the present disclosure. For example, the sub-system architecture 200 can be used by the computing system 210 (FIG. 2) to implement the embodiments described above, such as the functionality described in connection with FIGS. 2-7 and the method 100 of FIG. 1. According to the non-limiting aspect of FIG. 8, the sub-system architecture 800 can include one or more processor units 802ₐ, 802_{b}, that each can include, in the illustrated embodiment, multiple (N) sets of processor cores 804ₐ₋ₙ. Each processor unit 802ₐ, 802_{b} can include on-board memory (ROM or RAM) (not shown) and off-board memory 806ₐ, 806_{b} (which memory can include adequate VRAM for GPUs). The on-board memory can include primary, volatile and/or non-volatile storage (e.g., storage directly accessible by the processor cores 804ₐ₋ₙ). The off-board memory 806ₐ, 806_{b} can include secondary, non-volatile storage (e.g., storage that is not directly accessible by the processor cores 804_{A-N}), such as ROM, HDDs, SSD, flash, etc. The processor cores 804ₐ₋ₙ can include CPU cores, GPU cores, TPU cores, and/or AI accelerator cores (which can include TPUs, FPGAs, ASICs, and other types of processors). According to some embodiments, GPU cores can operate in parallel (e.g., a general-purpose GPU pipeline) and, hence, can typically process data more efficiently that a collection of CPU cores, but all the cores of the GPU can execute the same code at one time. According to the non-limiting aspects wherein the processor cores 804ₐ₋ₙ include AI accelerators, the AI accelerators can include a class of microprocessor designed to accelerate artificial neural networks. The AI accelerators can typically be employed as a co-processor in a device with a host processor 610, which can include a CPU, as well. An AI accelerator can include tens of thousands of matrix multiplier units that operate at lower precision than a CPU core, such as 8-bit precision in an AI accelerator versus 64-bit precision in a CPU core.

In various embodiments, the different processor cores 804 can be configured to train and/or implement different networks or subnetworks or components of the compacted fill determination engine. For example, according to some non-limiting aspects, the first processor unit 802ₐ can be configured to host and execute an optical flow model and the second processor unit 802_{b} can be configured to host and execute the static fullness model. However, according to other non-limiting aspects, a single processor unit 802ₐ, 802_{b}, can be configured to host and execute both models. In other words, the methods and functionality disclosed herein can be embodied as a set of instructions stored within a memory (e.g., an integral memory of the processing units 802ₐ, 802_{b} or an off board memory 806ₐ, 806_{b} coupled to the processing units 802ₐ, 802_{b} or other processing units) coupled to one or more processors (e.g., at least one of the sets of processor cores 804ₐ₋ₙ of the processing units 802ₐ, 802_{b} or another processor(s) communicatively coupled to the processing units 802ₐ, 802_{b}), such that, when executed by the one or more processors, the instructions cause the processors to perform the aforementioned process by, for example, controlling the models stored in the processing units 802ₐ, 802_{b}

As previously described, the sub-system architecture 800 can be implemented with one processor unit. In embodiments where there are multiple processor units, the processor units could be co-located or distributed. For example, the processor units may be interconnected by electronic data networks, such as a LAN, WAN, the Internet, etc., using suitable wired and/or wireless data communication links. Data may be shared between the various processing units using suitable data links, such as data buses (preferably high-speed data buses) or network links (e.g., Ethernet).

The software for the various computer systems described herein and other computer functions described herein may be implemented in computer software using any suitable computer programming language such as.NET, C, C++, Python, and using conventional, functional, or object-oriented techniques. Programming languages for computer software and other computer-implemented instructions may be translated into machine language by a compiler or an assembler before execution and/or may be translated directly at run time by an interpreter. Examples of assembly languages include ARM, MIPS, and x86; examples of high level languages include Ada, BASIC, C, C++, C #, COBOL, CUDA® (CUDA), Fortran, JAVA® (Java), Lisp, Pascal, Object Pascal, Haskell, ML; and examples of scripting languages include Bourne script, JAVASCRIPT®, PYTHON®, Ruby, LAU® (Lua), PHP, and PERL® (Perl).

Examples of the methods and systems disclosed herein, according to various aspects of the present disclosure, are provided below in the following embodiments. An aspect of the methods may include any one or more than one of, and any combination of, the embodiments described below.

According to a first non-limiting embodiment of the present disclosure, a computer-implemented method for determining compacted fill level within a container is provided. The method can include receiving, via a processor, sensor data associated with an interior of the container from a content sensor, detecting, via the processor, contents within the interior of the container based on the sensor data, generating, via the processor, a flow parameter associated with the contents based on the sensor data, and determining, via the processor, the compacted fill level within the container based on the flow parameter.

According to some non-limiting aspects, the flow parameter comprises a rate of flow, and the method further comprises determining, via the processor, a displacement of the contents based on the rate of flow, and wherein determining the compacted fill level within the container is further based on the displacement of the contents.

According to some non-limiting aspects, the sensor data comprises a plurality of images, and the method further comprises determining, via the processor, a change in the rate of flow based on consecutive images within the plurality of images, and wherein determining the compacted fill level within the container comprises correlating, via the processor, the change in the rate of flow to a fullness regime.

According to some non-limiting aspects, the flow parameter comprises a flow field, and the method further comprises determining, via the processor, a direction of a plurality of vectors within the flow field, and wherein determining the compacted fill level within the container comprises correlating, via the processor, the direction of the plurality of vectors within the flow field to a fullness regime.

According to some non-limiting aspects, the sensor data comprises a plurality of images, and the method further comprises generating, via the processor, an aggregate volume metric based on the plurality of images.

According to some non-limiting aspects, the method further includes determining, via the processor, a volume of contents added to the container since a prior compaction cycle based on the compacted fill level within the container, and modifying, via the processor, the aggregate volume metric to account for the volume of contents added to the container since the prior compaction cycle.

According to some non-limiting aspects, the method further includes causing, via the processor, the content sensor to generate additional sensor data associated with the interior of the container based on the compacted fill level within the container.

According to some non-limiting aspects, the method further includes causing, via the processor, the content sensor to alter a quality of the sensor data associated with the interior of the container based on the compacted fill level within the container.

According to some non-limiting aspects, the method further includes determining, via the processor, that only a subset of the sensor data associated with the interior of the container should be used to determine the compacted fill level within the container, and wherein determining the compacted fill level within the container is based on the subset of the sensor data.

According to some non-limiting aspects, the flow parameter comprises at least one of an optical flow vector, a descriptive statistic, an optical flow divergence metric, a summary statistic, a direction of maximal motion, a scalar, or a derived calculated property of the contents within the container, or combinations thereof.

According to some non-limiting aspects, the method further includes receiving, via the processor, an initial fullness metric from a static fullness model, and wherein determining the compacted fill level within the container is further based on the initial fullness metric.

According to some non-limiting aspects, determining the compacted fill level within the container comprises applying, via the processor, a weight to the initial fullness metric.

According to some non-limiting aspects, the flow parameter comprises a distance of travel of the contents within the container.

According to some non-limiting aspects, the method further includes detecting, via the processor, a trigger event within the container, and wherein receipt of the sensor data is based on the trigger event.

According to a second non-limiting embodiment of the present disclosure, a computing apparatus configured to determine a compacted fill level within a container is provided. The computing apparatus can include a processor and a memory configured to store a fullness optical flow model that, when executed by the processor, causes the computing apparatus to receive sensor data associated with an interior of the container from a content sensor, detect contents within the interior of the container based on the sensor data, generate a flow parameter associated with the contents based on the sensor data, and determine the compacted fill level within the container based on the flow parameter.

According to some non-limiting aspects, the flow parameter comprises a rate of flow, and when executed by the processor, the fullness optical flow model further causes the computing apparatus to determine a displacement of the contents based on the rate of flow, and wherein determining the compacted fill level within the container is further based on the displacement of the contents.

According to some non-limiting aspects, the flow parameter comprises a flow field and, when executed by the processor, the fullness optical flow model further causes the computing apparatus to determine a direction of a plurality of vectors within the flow field, and wherein determining the compacted fill level within the container comprises correlating, via the processor, the direction of the plurality of vectors within the flow field to a fullness regime.

According to a second non-limiting embodiment of the present disclosure, a system configured to determine a compacted fill level within a container is disclosed. The system can include a content sensor configured to generate sensor data associated with an interior of the container, and a computing apparatus communicatively coupled to the content sensor. The computing apparatus can include a processor and a memory configured to store a fullness optical flow model that, when executed by the processor, causes the computing apparatus to receive the sensor data associated with the interior of the container from the content sensor, detect contents within the interior of the container based on the sensor data, generate a flow parameter associated with the contents based on the sensor data, and determine the compacted fill level within the container based on the flow parameter.

According to some non-limiting aspects, when executed by the processor, the fullness optical flow model further causes the computing apparatus to cause the content sensor to generate additional sensor data associated with the interior of the container based on the compacted fill level within the container.

According to some non-limiting aspects, when executed by the processor, the fullness optical flow model further causes the computing apparatus to cause the content sensor to alter a quality of the sensor data associated with the interior of the container based on the compacted fill level within the container.

All patents, patent applications, publications, or other disclosure material mentioned herein, are hereby incorporated by reference in their entirety as if each individual reference was expressly incorporated by reference, respectively. All references, and any material, or portion thereof, that are said to be incorporated by reference herein are incorporated herein only to the extent that the incorporated material does not conflict with existing definitions, statements, or other disclosure material set forth in this disclosure. As such, and to the extent necessary, the disclosure as set forth herein supersedes any conflicting material incorporated herein by reference and the disclosure expressly set forth in the present application controls.

The present invention has been described with reference to various exemplary and illustrative aspects. The aspects described herein are understood as providing illustrative features of varying detail of various aspects of the disclosed invention; and therefore, unless otherwise specified, it is to be understood that, to the extent possible, one or more features, elements, components, constituents, ingredients, structures, modules, and/or aspects of the disclosed aspects may be combined, separated, interchanged, and/or rearranged with or relative to one or more other features, elements, components, constituents, ingredients, structures, modules, and/or aspects of the disclosed aspects without departing from the scope of the disclosed invention. Accordingly, it will be recognized by persons having ordinary skill in the art that various substitutions, modifications or combinations of any of the exemplary aspects may be made without departing from the scope of the invention. In addition, persons skilled in the art will recognize, or be able to ascertain using no more than routine experimentation, many equivalents to the various aspects of the invention described herein upon review of this specification. Thus, the invention is not limited by the description of the various aspects, but rather by the claims

Those skilled in the art will recognize that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although claim recitations are presented in a sequence(s), it should be understood that the various operations may be performed in other orders than those which are described or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “an exemplification,” “one exemplification,” and the like means that a particular feature, structure, or characteristic described in connection with the aspect is included in at least one aspect. Thus, appearances of the phrases “in one aspect,” “in an aspect,” “in an exemplification,” and “in one exemplification” in various places throughout the specification are not necessarily all referring to the same aspect. Furthermore, the particular features, structures or characteristics may be combined in any suitable manner in one or more aspects.

As used herein, the singular form of “a,” “an,” and “the” include the plural references unless the context clearly dictates otherwise.

Directional phrases used herein, such as, for example and without limitation, top, bottom, left, right, lower, upper, front, back, and variations thereof, shall relate to the orientation of the elements shown in the accompanying drawing and are not limiting upon the claims unless otherwise expressly stated.

The terms “about” or “approximately” as used in the present disclosure, unless otherwise specified, means an acceptable error for a particular value as determined by one of ordinary skill in the art, which depends in part on how the value is measured or determined. In certain aspects, the term “about” or “approximately” means within 1, 2, 3, or 4 standard deviations. In certain aspects, the term “about” or “approximately” means within 50%, 200%, 105%, 100%, 9%, 8%, 7%, 6%, 5%, 4%, 3%, 2%, 1%, 0.5%, or 0.05% of a given value or range.

In this specification, unless otherwise indicated, all numerical parameters are to be understood as being prefaced and modified in all instances by the term “about,” in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described herein should at least be construed in light of the number of reported significant digits and by applying ordinary rounding techniques.

Any numerical range recited herein includes all sub-ranges subsumed within the recited range. For example, a range of “1 to 100” includes all sub-ranges between (and including) the recited minimum value of 1 and the recited maximum value of 100, that is, having a minimum value equal to or greater than 1 and a maximum value equal to or less than 100. Also, all ranges recited herein are inclusive of the end points of the recited ranges. For example, a range of “1 to 100” includes the end points 1 and 100. Any maximum numerical limitation recited in this specification is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited. All such ranges are inherently described in this specification.

Any patent application, patent, non-patent publication, or other disclosure material referred to in this specification and/or listed in any Application Data Sheet is incorporated by reference herein, to the extent that the incorporated materials is not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system that “comprises,” “has,” “includes” or “contains” one or more elements possesses those one or more elements but is not limited to possessing only those one or more elements. Likewise, an element of a system, device, or apparatus that “comprises,” “has,” “includes” or “contains” one or more features possesses those one or more features but is not limited to possessing only those one or more features.

Instructions used to program logic to perform various disclosed aspects can be stored within a memory in the system, such as dynamic random-access memory (DRAM), cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, compact disc, read-only memory (CD-ROMs), and magneto-optical disks, read-only memory (ROMs), random-access memory (RAM), erasable programmable read-only memory (EPROM), electrically erasable programmable read-only memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the non-transitory computer-readable medium includes any type of tangible machine-readable medium suitable for storing or transmitting electronic instructions or information in a form readable by a machine (e.g., a computer).

As used in any aspect herein, the term “control circuit” may refer to, for example, hardwired circuitry, programmable circuitry (e.g., a computer processor including one or more individual instruction processing cores, processing unit, processor, microcontroller, microcontroller unit, controller, digital signal processor (DSP), programmable logic device (PLD), programmable logic array (PLA), or field programmable gate array (FPGA)), state machine circuitry, firmware that stores instructions executed by programmable circuitry, and any combination thereof. The control circuit may, collectively or individually, be embodied as circuitry that forms part of a larger system, for example, an integrated circuit (IC), an application-specific integrated circuit (ASIC), a system on-chip (SoC), desktop computers, laptop computers, tablet computers, servers, smart phones, etc. Accordingly, as used herein “control circuit” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microcontroller configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

As used in any aspect herein, the term “logic” may refer to an app, software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices.

As used in any aspect herein, the terms “component,” “system,” “module” and the like can refer to a computer-related entity, either hardware, a combination of hardware and software, software, or software in execution.

As used in any aspect herein, an “algorithm” refers to a self-consistent sequence of steps leading to a desired result, where a “step” refers to a manipulation of physical quantities and/or logic states which may, though need not necessarily, take the form of electrical or magnetic signals capable of being stored, transferred, combined, compared, and otherwise manipulated. It is common usage to refer to these signals as bits, values, elements, symbols, characters, terms, numbers, or the like. These and similar terms may be associated with the appropriate physical quantities and are merely convenient labels applied to these quantities and/or states.

A network may include a packet switched network. The communication devices may be capable of communicating with each other using a selected packet switched network communications protocol. One example communications protocol may include an Ethernet communications protocol which may be capable permitting communication using a Transmission Control Protocol/Internet Protocol (TCP/IP). The Ethernet protocol may comply or be compatible with the Ethernet standard published by the Institute of Electrical and Electronics Engineers (IEEE) titled “IEEE 802.3 Standard,” published in December 2008 and/or later versions of this standard. Alternatively, or additionally, the communication devices may be capable of communicating with each other using an X.25 communications protocol. The X.25 communications protocol may comply or be compatible with a standard promulgated by the International Telecommunication Union-Telecommunication Standardization Sector (ITU-T). Alternatively, or additionally, the communication devices may be capable of communicating with each other using a frame relay communications protocol. The frame relay communications protocol may comply or be compatible with a standard promulgated by Consultative Committee for International Telegraph and Telephone (CCITT) and/or the American National Standards Institute (ANSI). Alternatively, or additionally, the transceivers may be capable of communicating with each other using an Asynchronous Transfer Mode (ATM) communications protocol. The ATM communications protocol may comply or be compatible with an ATM standard published by the ATM Forum titled “ATM-MPLS Network Interworking 2.0” published August 2001, and/or later versions of this standard. Of course, different and/or after-developed connection-oriented network communication protocols are equally contemplated herein.

Unless specifically stated otherwise as apparent from the foregoing disclosure, it is appreciated that, throughout the foregoing disclosure, discussions using terms such as “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

One or more components may be referred to herein as “configured to,” “configurable to,” “operable/operative to,” “adapted/adaptable,” “able to,” “conformable/conformed to,” etc. Those skilled in the art will recognize that “configured to” can generally encompass active-state components and/or inactive-state components and/or standby-state components unless context requires otherwise.

What is claimed is:

1. A computer-implemented method for determining compacted fill level within a container, the method comprising:
receiving, via a processor, sensor data associated with an interior of the container from a content sensor;
detecting, via the processor, contents within the interior of the container based on the sensor data;
generating, via the processor, a flow parameter associated with the contents based on the sensor data; and
determining, via the processor, the compacted fill level within the container based on the flow parameter.

2. The method of claim 1, wherein the flow parameter comprises a rate of flow, and wherein the method further comprises:
determining, via the processor, a displacement of the contents based on the rate of flow, and wherein determining the compacted fill level within the container is further based on the displacement of the contents.

3. The method of claim 2, wherein the sensor data comprises a plurality of images, and wherein the method further comprises:
determining, via the processor, a change in the rate of flow based on consecutive images within the plurality of images, and wherein determining the compacted fill level within the container comprises correlating, via the processor, the change in the rate of flow to a fullness regime.

4. The method of claim 1, wherein the flow parameter comprises a flow field, and wherein the method further comprises:
determining, via the processor, a direction of a plurality of vectors within the flow field, and wherein determining the compacted fill level within the container comprises correlating, via the processor, the direction of the plurality of vectors within the flow field to a fullness regime.

5. The method of claim 1, wherein the sensor data comprises a plurality of images, and wherein the method further comprises:
generating, via the processor, an aggregate volume metric based on the plurality of images.

6. The method of claim 5, further comprising:
determining, via the processor, a volume of contents added to the container since a prior compaction cycle based on the compacted fill level within the container; and
modifying, via the processor, the aggregate volume metric to account for the volume of contents added to the container since the prior compaction cycle.

7. The method of claim 1, further comprising:
causing, via the processor, the content sensor to generate additional sensor data associated with the interior of the container based on the compacted fill level within the container.

8. The method of claim 1, further comprising:
causing, via the processor, the content sensor to alter a quality of the sensor data associated with the interior of the container based on the compacted fill level within the container.

9. The method of claim 1, further comprising:
determining, via the processor, that only a subset of the sensor data associated with the interior of the container should be used to determine the compacted fill level within the container, and wherein determining the compacted fill level within the container is based on the subset of the sensor data.

10. The method of claim 1, wherein the flow parameter comprises at least one of an optical flow vector, a descriptive statistic, an optical flow divergence metric, a summary statistic, a direction of maximal motion, a scalar, or a derived calculated property of the contents within the container, or combinations thereof.

11. The method of claim 1, further comprising:
receiving, via the processor, an initial fullness metric from a static fullness model, and wherein determining the compacted fill level within the container is further based on the initial fullness metric.

12. The method of claim 11, wherein determining the compacted fill level within the container comprises applying, via the processor, a weight to the initial fullness metric.

13. The method of claim 1, wherein the flow parameter comprises a distance of travel of the contents within the container.

14. The method of claim 1, further comprising:
detecting, via the processor, a trigger event within the container, and wherein receipt of the sensor data is based on the trigger event.

15. A computing apparatus configured to determine a compacted fill level within a container, the computing apparatus comprising:
a processor; and
a memory configured to store a fullness optical flow model that, when executed by the processor, causes the computing apparatus to:
receive sensor data associated with an interior of the container from a content sensor;
detect contents within the interior of the container based on the sensor data;
generate a flow parameter associated with the contents based on the sensor data; and
determine the compacted fill level within the container based on the flow parameter.

16. The computing apparatus of claim 15, wherein the flow parameter comprises a rate of flow, and wherein, when executed by the processor, the fullness optical flow model further causes the computing apparatus to:
determine a displacement of the contents based on the rate of flow, and wherein determining the compacted fill level within the container is further based on the displacement of the contents.

17. The computing apparatus of claim 15, wherein the flow parameter comprises a flow field, and wherein, when executed by the processor, the fullness optical flow model further causes the computing apparatus to:
determine a direction of a plurality of vectors within the flow field, and wherein determining the compacted fill level within the container comprises correlating, via the processor, the direction of the plurality of vectors within the flow field to a fullness regime.

18. A system configured to determine a compacted fill level within a container, the system comprising:
a content sensor configured to generate sensor data associated with an interior of the container; and
a computing apparatus communicatively coupled to the content sensor, the computing apparatus comprising a processor and a memory configured to store a fullness optical flow model that, when executed by the processor, causes the computing apparatus to:
receive the sensor data associated with the interior of the container from the content sensor;
detect contents within the interior of the container based on the sensor data;
generate a flow parameter associated with the contents based on the sensor data; and
determine the compacted fill level within the container based on the flow parameter.

19. The system of claim 18, wherein, when executed by the processor, the fullness optical flow model further causes the computing apparatus to:
cause the content sensor to generate additional sensor data associated with the interior of the container based on the compacted fill level within the container.

20. The system of claim 18, wherein, when executed by the processor, the fullness optical flow model further causes the computing apparatus to:
cause the content sensor to alter a quality of the sensor data associated with the interior of the container based on the compacted fill level within the container.
